(19) United States
(12) Patent Application Publication
(10) Pub. No.: US 2004/0226579 A1
(43) Pub. Date: Nov. 18, 2004

(54) Apparatus and process for the continuous treatment of a continuous material

(75) Inventors: Jovan Starcevic, Vienna (AT); Erich Mahr, Purkersdorf (AT)

Correspondence Address: ROYLANCE, ABRAMS, BERDO & GOODMAN, L.L.P., 1300 19TH STREET, N.W., SUITE 600, WASHINGTON,, DC, 20036, US

(73) Assignee: Andritz AG

(21) Appl. No.: 10/356,728

(22) Filed: Feb. 3, 2003

(30) Foreign Application Priority Data
Feb. 4, 2002 (AT) A 177/2002

(51) Int. Cl. B08B 3/04

(52) U.S. Cl. 134/15; 134/18; 134/64 R; 134/56 R; 134/199

(57) ABSTRACT

A device for pickling strip-shaped or wire-shaped material has guiding mechanisms for feeding and guiding the material in a serpentine path formed by several loops having vertical sections and liquid delivery devices positioned to bring the material into contact with a pickling liquid. At least two vertical pickling cells are provided in the apparatus, each with two vertical sections. Each of the individual cells are activated and deactivated optionally and independently of one another to be able to change or set the effective pickling length exactly, even in purely chemical pickling processors, and thus obtain a precisely definable, variable pickling effect, while retaining the space-saving design of the plant.

### FIELD OF THE INVENTION

The present invention relates to an apparatus and process for pickling a continuous strip material in the form of a continuous sheet or continuous wire. The invention is particularly directed to an apparatus having guiding mechanisms for the continuous strip material for feeding the strip material in several loops having vertical sections and liquid delivery devices to bring the strip material into contact with the pickling liquid.

### BACKGROUND OF THE INVENTION

Various continuous pickling devices are known in the art for applying a pickling liquid to a continuously moving strip of material. Many of these devices include a bath where the strip material is immersed in the bath as it is conveyed through the device. Other continuous pickling devices including one or more sprayers to spray a continuous stream of the pickling liquid onto the surfaces of the continuous strip.

Another type of pickling apparatus is disclosed in Austrian Patent No. 206247 B1. This patent discloses a pickling apparatus having a pickling tower that contains one or more vertically oriented loops of the continuous strip material. Spray nozzles are provided in the tower to apply the pickling medium directly to the strip material.

A similar apparatus is disclosed in Austrian Patent No. 218331 B1. The patent discloses the pickling apparatus having a pickling tower where the pickling medium is sprayed onto the strip material which is guided vertically in several loops. The apparatus includes a concentric nozzle surrounding the strip material so that the pickling medium flows downward over the strip material. The pickling apparatus disclosed in these patents provide a long length of the strip material that is subjected to the pickling liquid while minimizing the floor space required for the apparatus.

These prior pickling apparatus that include vertical sections have a fixed length of the strip material that is contacted with the pickling medium. Thus, it is not possible to vary the pickling effect by changing the length of the strip material that is contacted with the pickling medium such as in purely chemical pickling processes. Conventional horizontal pickling tanks where the strip material is fed through a pickling tank filled with the pickling medium do not allow variation in the pickling effect by the pickling medium. One proposal to control the pickling effect is disclosed in German Patent Application No. 4240572 A1. The apparatus disclosed in this patent application having horizontal sections includes additional injection nozzles within the pickling tanks to control the amount of the pickling medium contacting the strip material. This apparatus does not allow the control of the pickling action in selected areas or to distinguish between areas within the pickling tank where a strong pickling action takes place compared to a poor pickling action. In addition, this apparatus has a predetermined length of the pickling tank and the length of the strip material that is subjected to the pickling medium.

Another example of a horizontal pickling tank is disclosed in U.S. Pat. No. 4,807,653, which discloses a series of consecutive pickling cells. The pickling cells are sealed off by rollers at each end which convey the strip material through the apparatus. The rollers do not permit complete separation of the individual pickling cells or sections. Although the squeezed rollers remove a portion of the pickling medium, there is always a certain amount of the pickling medium that remains on the strip material and is carried into the subsequent pickling cells. The pickling medium is also carried into the rinse station where the strip material is contacted with a rinsing or flushing medium. This apparatus also does not allow a change in the length of the strip material that is subjected to the pickling medium.

The prior pickling apparatus are generally effective for their intended use but have experienced various limitations. Accordingly, there is a need in the industry for an improved pickling apparatus and process for controlling the pickling effect on the strip material.

### SUMMARY OF THE INVENTION

The present invention is directed to a process and apparatus for pickling a continuous strip of material such as a continuous sheet or continuous wire-shaped material. The invention is also directed to an apparatus that is able to control the effective length of the strip material within the pickling apparatus, control the extent of the pickling effect on the strip material and to control the effective length of the strip material that is contacted with the pickling medium.

Accordingly, a primary aspect of the invention is to provide a pickling apparatus that is able to select and change the effective pickling length of a strip material within the pickling apparatus in a precise manner. The effective pickling length as used herein refers to the length of the section of the strip material that is being contacted with and treated by the pickling medium at any one time as the continuous strip material is conveyed through the pickling apparatus.

A further aspect of the invention is to provide a pickling apparatus and process that can be a purely chemical pickling process where the pickling effect is controlled and adjustable while reducing the amount of floor space required for the pickling plant and apparatus.

Another aspect of the invention is to provide a pickling apparatus and process where the apparatus includes a plurality of liquid treating cells arranged in sequence where each of the cells can be selectively controlled to control the pickling effect on the continuous strip material within the respective pickling cell.

Still another aspect of the invention is to provide a pickling apparatus and process where the apparatus includes a plurality of guide members for feeding a continuous material in a serpentine path defining a plurality of loops where each loop defines a pickling cell. The supply and flow of pickling medium delivered to each of the pickling cells is monitored and controlled to control the effect of the pickling medium on the length of the continuous material within the respective pickling cell and the pickling effect of the continuous material as it moves continuously through the apparatus.

A further aspect of the invention is to provide an apparatus having at least two vertical pickling cells where each of the pickling cells includes two vertical sections of the strip material that is subjected to the pickling medium. The supply of the pickling medium to each of the individual pickling cells is activated and deactivated independently of one another to selectively control the amount of the pickling medium supplied to the strip material within a respective pickling cell and within the entire apparatus. In this manner, the pickling effect on the strip material can be controlled without changing the speed of the strip material through the apparatus. The vertical arrangement of the pickling cells allows a large pickling length of the strip material to be treated and allows selected changes in the effective length of the strip material that is subjected to the pickling medium. Selectively and independently activating or deactivating the entire pickling cell or portions of the pickling cell provides improved drainage of the pickling medium from the strip material to reduce the amount of pickling medium that is transferred to subsequent cells or to the rinsing station.

A further aspect of the invention is to provide a pickling apparatus having a plurality of pickling cells where each of the pickling cells include a guide assembly for defining at least two vertical sections in the strip material being processed. A liquid supply device is positioned to supply a flow of the pickling medium against each of the vertical sections of the strip material. The supply devices for each of the vertical sections are connected to a control device to selectively control the flow of the pickling medium to each of the supply devices and independently of one another within a pickling cell. Selectively actuating each of the liquid supply devices effectively subdivides the pickling apparatus into pickling zones so that each pickling zone can be controlled to adjust the effective length of the strip material being subjected to the pickling medium.

Another aspect of the invention is to provide a pickling apparatus and process having at least five pickling cells provided in sequence where each of the pickling cells include two vertical sections of the continuous strip material. Each of the vertical sections include a supply device for supplying a pickling medium to each of the vertical sections. By selectively controlling the supply devices and controlling the amount of the pickling medium directed to the strip material, the effective length of the strip material subjected to the pickling medium can be adjusted between 0 and 100% in 10% increments, thereby providing precise adjustments in the extent of the pickling process that is desired.

The various aspects of the invention are basically attained by providing a pickling apparatus for pickling a continuous material. The pickling apparatus comprises a first liquid treating cell that has a feed device for continuously feeding the continuous material in a substantially vertical loop with first and second vertical sections. A first fluid supply device supplies the pickling liquid onto the continuous material on the first and second vertical sections. At least one second liquid treating cell has a feed device for receiving the continuous material from the first liquid treating cell and continuously feeding the continuous strip in a substantially vertical loop which has first and second vertical sections. A second fluid supply device supplies the pickling liquid onto the continuous material on the two vertical sections. A control device is connected to the first liquid supply device and to the second liquid supply device for independently controlling a flow of the pickling liquid from the first liquid supply device and the second liquid supply device.

The aspects of the invention are also attained by providing a pickling apparatus for pickling a continuous material. The pickling apparatus comprises a plurality of liquid pickling cells arranged in sequence for treating the continuous material with a pickling liquid. Each of the liquid pickling cells has a first guide roller at a top end of the treating cell and a second guide roller at a bottom end of the cell for guiding the continuous material in a substantially vertical loop which has a first vertical section extending between the first guide roller and second guide roller and a second vertical section extending between the second guide roller and a first guide roller of an adjacent liquid pickling cell. Each cell has a liquid supply device for supplying the pickling liquid to the first and second vertical sections of the continuous material. A control device is coupled to the liquid supply for selectively and independently controlling the supply of pickling liquid to each cell.

The various aspects of the invention are further attained by providing a process of pickling a continuous steel material. The process comprises the steps of feeding the continuous steel material through a plurality of sequentially arranged liquid treating cells. Each of the cells has an upper guide roller and lower guide roller to guide the steel material in a substantially U-shaped loop within each of the cells and form a first and second vertical section. A dispensing device is provided in each of the cells for directing a pickling liquid onto each of the first and second vertical sections. Each dispensing device is selectively controlled to selectively operate the dispensing device within a cell independently of the operation of a dispensing device of another cell.

These and other aspects of the invention will become apparent from the following detailed description of the invention, which in conjunction with the annexed drawings, disclose various embodiments of the invention.

### BRIEF DESCRIPTION OF THE DRAWING

The following is a brief description of the drawings in which:

FIG. 1 is a schematic view of the pickling apparatus in one embodiment of the invention showing the pickling cells of the apparatus arranged in sequence;

FIG. 2 is a schematic diagram of the pickling apparatus in another embodiment of the invention showing a first section having a plurality of pickling cells arranged in sequence followed by a second section positioned downstream of the first section of pickling cells; and

FIG. 3 is a schematic diagram of another embodiment of the invention showing the plurality of pickling cells arranged in first and second sections and a supplemental spray nozzle for supplying additional pickling medium to the strip material.

### DETAILED DESCRIPTION OF THE INVENTION

The present invention is directed to an apparatus and process for contacting a continuous material with a treating liquid. The invention is particularly directed to an apparatus and process for supplying a pickling liquid medium to a continuous material in a controlled manner to control the pickling effect on the continuous material. The apparatus and process are able to control the pickling effect within selected pickling cells in the apparatus and control the complete pickling effect as the continuous material passes through the apparatus.

The continuous material that is treated by the apparatus and process of the invention is typically steel or stainless steel. The steel or stainless steel continuous material can be a hot rolled or a cold rolled steel or stainless steel as known in the art. The continuous material can be in the form of a continuous strip or sheet or in the form of a wire or rope. As used herein, the continuous material or continuous strip material refer to a continuous substrate that can be in any suitable shape or form that can be continuously fed through the apparatus and continuously treated with a pickling solution. The continuous material is supplied from a supply roll or manufacturing facility, fed through the pickling apparatus and recovered on a spool.

The pickling medium is typically a pickling acid or mixed acid as known in the art of pickling steel and stainless steel. The pickling acid can include an acid selected from the group consisting of hydrochloric acid, sulfuric acid, nitric acid, hydrofluoric acid, phosphoric acid, and mixtures thereof.

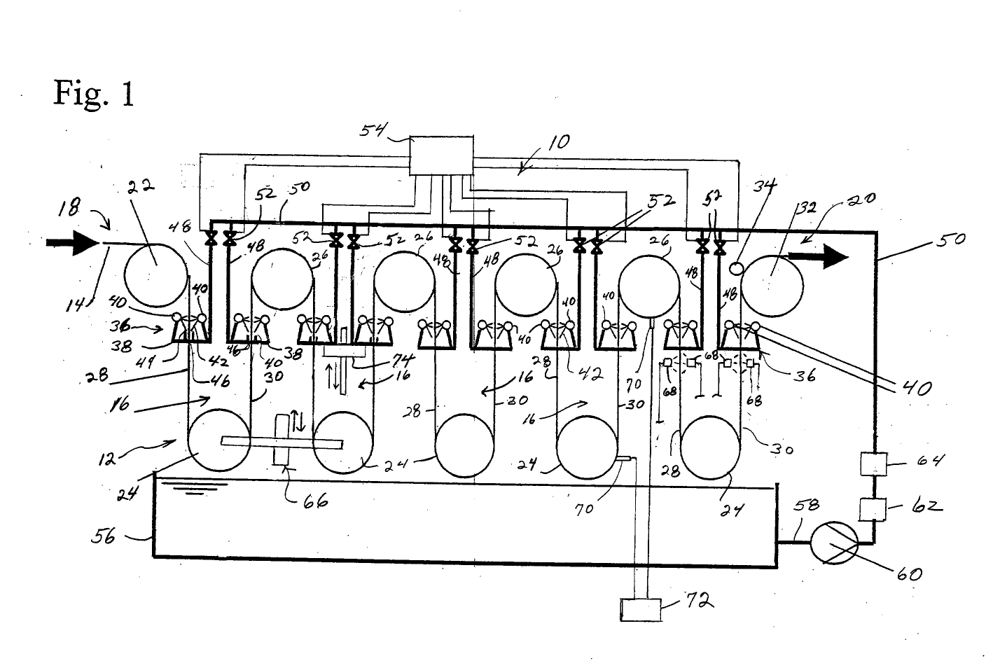

FIG. 1 is a schematic diagram of a pickling apparatus in a first embodiment of the invention. Referring to FIG. 1, apparatus 10 includes a feed and guide assembly 12 for continuously feeding a continuous material 14 through apparatus 10 in a substantially serpentine path. The continuous material hereinafter is referred to as strip material 14 which can be in any suitable form such as a sheet, flat strip, wire or rope. Guide assembly 12 defines a plurality of pickling cells 16 arranged in sequence from an inlet end 18 to an outlet end 20.

Strip material 14 is guided around a first guide roller 22 positioned at the inlet end 18 of assembly 10. Guide roller 22 receives strip material 14 from a supply (not shown) and directs the strip material in a substantially downward direction to a second guide roller 24. Second roller 24 is positioned below first guide roller 22 to direct strip material 14 in a substantially vertical path while continuously conveying strip material 14 through apparatus 10. The length of strip material 14 extending between first guide roller 22 and second guide roller 24 defines a first vertical section within the respective pickling cell 16. An upper roller 26 is positioned above second roller 24 and adjacent the first guide roller 22 to direct strip material 14 upwardly from second roller 24 and to define a second vertical section of strip material 14 extending between second roller 24 and upper roller 26. First guide roller 22, second roller 24 and upper roller 26 define a first of the pickling cells 16 for treating strip material 14 with a pickling liquid.

As shown in FIG. 1, a plurality of the upper rollers 26 are spaced apart along the length of apparatus 10. A plurality of lower rollers 24 are also spaced apart and oriented to align with upper rollers 26 for continuously guiding strip material 14 in the serpentine path. Each of the lower rollers 24 cooperate with upper rollers 26 to define the respective pickling cells 16 and to form a first vertical section 28 and a second vertical section 30 of strip material 14 within each cell 16. As shown in FIG. 1, each upper roller 26 cooperates with two adjacent pickling cells 16 to guide strip material 14 from second vertical section 30 of a first pickling cell to a first vertical section 28 of an adjacent pickling cell 16. As shown, first vertical section 28 and second vertical section 30 of strip material 14 are substantially parallel and oriented substantially perpendicular to the longitudinal dimension of apparatus 10. In this manner, each pickling cell 16 includes two vertical sections of strip material 14. It is to be understood that strip material 14 is preferably being continuously conveyed through apparatus 10 so that the various sections of strip material 14 are intended to refer to the strip material within a specified area at any one time.

In the embodiment illustrated in FIG. 1, apparatus 10 includes five pickling cells 16 arranged in sequence for continuously receiving strip material 14 and providing an effective pickling length for treating the strip material. The outlet end 20 of assembly 10 includes a guide roller 8 positioned above the downstream lower roller 24 for directing strip material 14 to a subsequent processing station or to a suitable winding roll as desired. A squeeze or press roller 34 is provided at outlet end 20 to cooperate with second guide roller 32 to remove the pickling medium or rinse medium from strip material 14 before exiting apparatus 10. Although five pickling cells 16 are illustrated in the embodiment of FIG. 1, the actual number of pickling cells can vary depending on the spacing between the lower rollers 24 and the upper rollers 26 and the desired effective length of the pickling zone subjected to the pickling medium.

The height of the individual pickling cells 16 can vary depending on the number of pickling cells within apparatus 10 and the desired maximum and/or minimum effective pickling length of the strip material to be treated with the pickling medium. Typically, each vertical section of strip material 14 within each pickling cell 16 has an effective pickling length of about 1 to about 10 meters, with lengths between about 3 and 6 meters being preferred. In more preferred embodiments, the effective pickling length for each vertical section of strip material 14 within each pickling cell is about 3.5 meters. In this manner, the effective pickling length of apparatus 10 is about 35 meters in the embodiment of FIG. 1 where five pickling cells 16 are provided. By arranging the upper and lower rollers to form the serpentine path of the strip material 14, the horizontal length of apparatus 10 is typically about 10 meters, which is less than ⅓ of the length of a conventional horizontal pickling line apparatus.

Referring to FIG. 1, a liquid supply device 36 is provided within each pickling cell 16 for supplying a pickling medium to strip material 14 as it is conveyed through each pickling cell 16. Typically, liquid supply device 36 is positioned at an upper end within each pickling cell 16 so that the pickling medium is supplied to strip material 14 at an inlet end of each pickling cell 16.

In preferred embodiments, liquid supply device 36 includes two liquid dispensing units 38 within each pickling cells 16. Liquid dispensing units 38 in the embodiment illustrated include a spray nozzle 40 positioned on opposite sides of strip material 14 to direct a spray 42 of the pickling medium against opposite sides of strip material 14. Preferably, liquid dispensing units 38 are positioned at an upper end of first horizontal section 28 and second horizontal section 30 so that the pickling medium flow downward over the sections of strip material 14. Liquid dispensing units 38 in one embodiment also include a dam 44 to form an overflow 46 of the pickling medium to ensure a continuous layer of the pickling medium on first vertical section 28 and second vertical section 30 of strip material 14 within each pickling cell 16. Overflow 46 of pickling medium flows downwardly to provide continuous coating of strip material 14 with the pickling medium.

In preferred embodiments, each liquid dispensing unit 38 is supplied with the pickling medium through a conduit 48 which is connected to a main supply line 50. Each conduit 48 includes a control valve 52 for independently controlling the flow of the pickling medium to each spray nozzle 40. Each valve 52 is connected to a control device 54. Control device 54 selectively actuates each valve 52 independently of one another to control the flow and supply of the pickling medium to each horizontal section within a given pickling cell 16 and to control the flow of pickling medium independently to each of the pickling cells 16. Control device 54 can be a microprocessor or other suitable control device capable of selectively actuating each valve 52 as known in the art. Control device 54 is able to selectively activate or deactivate liquid dispensing units 38 by opening and closing valves 52 within each of pickling cell 16 independent of the treating process in another cell.

A collection tank 56 is positioned below each pickling cell 16 to collect the pickling medium that drains from strip material 14 as it passes through each of the pickling cells 16. Collection tank 56 includes an outlet pipe 58 which supplies the collected pickling medium to a pump 60. Pump 60 pumps the pickling medium from collection tank 56 to supply line 50 to recirculate the pickling medium. A suitable filter 62 and a feed device 64 for supplying fresh or regenerated pickling acid to the system are included in supply line 50. In this embodiment, a single collection tank 56 is provided to collect the spent pickling medium that drains from the individual pickling cells.

In one embodiment, apparatus 10 can include an adjusting assembly 66 connected to one or more of lower rollers 24 to selectively adjust the height of lower roller 24 with respect to the adjacent upper rollers 26. Adjusting assembly 66 is capable of selectively adjusting the height of the lower roller 24 to increase or decrease the length of a first vertical section 28 and a second vertical section 30 in a respective or adjacent pickling cells 16. In this manner, the effective pickling length of the strip material can be selectively adjusted.

Control device 54 selectively operates valves 52 to control the flow of pickling medium within apparatus 10 and to control the amount of pickling medium that contacts the strip material 14. In one embodiment, control device 54 can actuate each valve 52 to supply pickling medium to each spray nozzle 40 and the amount of pickling medium supplied to each spray nozzle 40 to provide a maximum pickling effect on strip material 14. In embodiments where it is unnecessary or undesirable to treat strip material 14 with a maximum amount of the pickling medium that is capable of apparatus 10, control device 54 can selectively and independently close one or more valves 52 to reduce the flow of pickling liquid that is supplied to strip material 14. Valves 52 can be closed in a respective pickling cell 16 so that no pickling medium is supplied to strip material 14 in the respective pickling cell 16. When valves 52 of a pickling cell 16 are closed so that no pickling medium is supplied, it is generally preferred to deactivate one or more of the pickling cells at the upstream end of apparatus 10. In other embodiments, a single valve 52 for each pickling cell 16 is closed so that only one of the two spray nozzles in each pickling cell 16 supplies pickling medium to the strip material 14. Either of valves 52 can be deactivated depending on the desired pickling effect.

In embodiments where one or more of valves 52 are closed, the rinse liquid can be supplied to the strip material to keep the strip material wet or damp, thereby avoiding streaking or staining. In one embodiment, mist projector or mist spray devices 68 are provided in at least one pickling cell 16 that is capable of supplying a rinsing liquid to contact strip material 14. In one embodiment, mist spray device 68 is operatively connected to control device 54 to control the timing and amount of the spray, and to activate and deactivate mist spray device 68. Typically, mist spray device 68 forms a light mist or spray of a rinse liquid that is sufficient to prevent strip material from drying without completely rinsing strip material as in a conventional rinsing station. The mist spray device 68 is preferably positioned next or proximate dispensing units 38 on both sides of continuous strip material 14 as shown in FIG. 1. Mist spray devices 68 arranged close to liquid dispensing units 38 can provide a continuous mist that can rinse along the vertical sections of the continuous strip material to prevent the continuous strip material from coming into contact with the atmosphere, thereby preventing or inhibiting oxidation. In one embodiment, mist spray devices 68 are actuated in response to a deactivation of liquid dispensing unit 38 in a respective liquid treating cell to prevent continuous strip material 14 from drying and being exposed to the air. In the embodiment illustrated, the downstream liquid treating cell includes mist spray devices 68, although more than one or all of the cells can be provided with mist spray devices.

Apparatus 10 generally uses a chemical pickling process where the strip material is treated with a pickling acid or mixed acid. In one embodiment, apparatus 10 can include electrodes 70 to apply an electric potential to one or more sections of strip material 14. As shown in FIG. 1, electrodes 70 are connected to one upper roller 26 and lower roller 24 within a pickling cell to apply an electric potential to strip material 14 within the respective pickling cell. Electrodes 70 are connected to a suitable electric power source 72. The current and voltage applied to electrodes 70 are as known in the art for the electrolytic treatment of steel and stainless steel. In the illustrated embodiment, one section is provided with electrodes to electrolytically treat the strip material. In other embodiments, more than one section or pickling cell can electrolytically treat the strip material.

The effective length of the treatment within each pickling cell 16 is dependent on the distance between spray nozzles 40 and lower rollers 24. Preferably, liquid dispensing units 38 provide a continuous flow of the pickling medium to form a continuous film that flows downwardly toward lower roller 24. In one embodiment, liquid dispensing units 38 can be mounted on an adjustable rack 74 for selectively adjusting the height of liquid dispensing units 38 with respect to lower roller 24 within a given pickling cell 16.

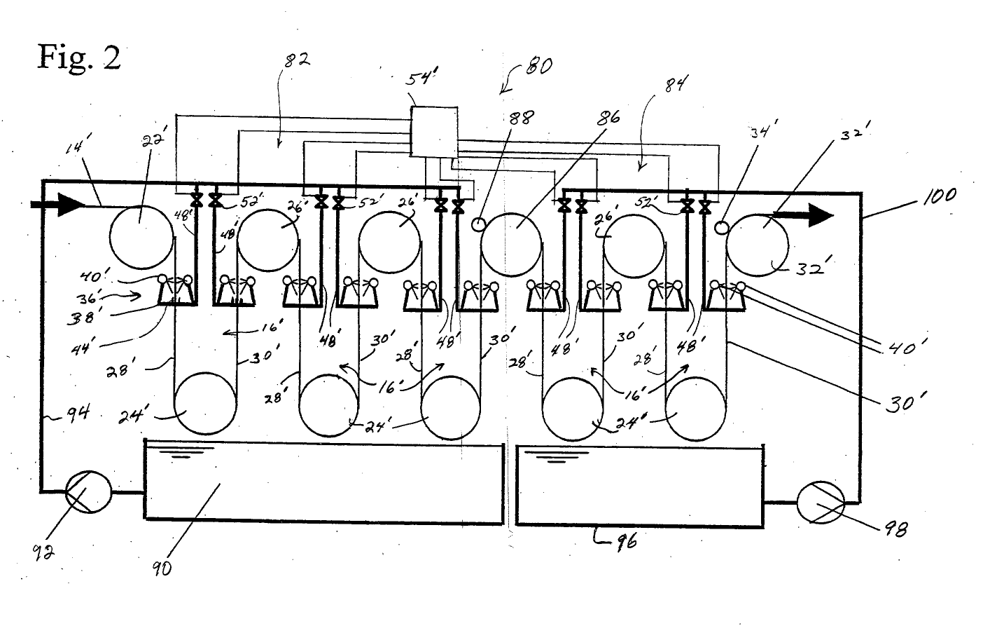

FIG. 2 shows a pickling apparatus 80 in a second embodiment of the invention. Pickling apparatus 80 is similar to the embodiment of FIG. 1 so that identical elements are identified by the same reference number with the addition of a prime. As shown in FIG. 2, apparatus 80 includes a plurality of lower rollers 24′ and upper rollers 26′ to guide strip material 14′ in a serpentine path through apparatus 80. Liquid dispensing units 38′ are provided within each pickling cell 16′ to supply pickling medium to first vertical section 28′ and second vertical section 30′ within each pickling cell 16′.

In the embodiment of FIG. 2, apparatus 80 has a first pickling section 82 positioned upstream with respect to apparatus 80 and a second pickling section 84 positioned downstream of first pickling section 82. An upper roller 86 is positioned to guide strip material 14′ from first pickling section 82 to second pickling section 84. A press roller 88 cooperates with roller 86 to remove the pickling medium from strip material 14′ before feeding strip material 14′ to second pickling section 84.

First pickling section 82 includes a collection tank 90 positioned below the respective pickling cells 16′ for collecting the pickling medium. In the embodiment illustrated, first pickling section 82 includes three pickling cells 16′. The collected pickling medium is directed by a pump 92 to a supply line 94. Supply line 94 supplies the pickling medium through valves 52′ and conduits 48′ as in the previous embodiment. A collection tank 96 is positioned below pickling cells 16′ of second section 84 to collect the pickling medium draining from strip material 14′. The pickling medium is supplied by a pump 98 to a supply line 100. Supply line 100 feeds the pickling medium through valves 52′ of conduits 48′ to liquid dispensing units 38′ within second pickling section 84.

In the embodiment of FIG. 2, first pickling section 82 and second pickling section 84 supply a pickling medium to the continuous strip 14′. Control device 54′ independently actuates each dispensing unit 38′ within each of the pickling cells 16′ of first pickling section 82 and second pickling section 84. In one embodiment, second pickling section 84 can include a rinse liquid to rinse the pickling medium from strip material 14′ before discharging from pickling apparatus 80.

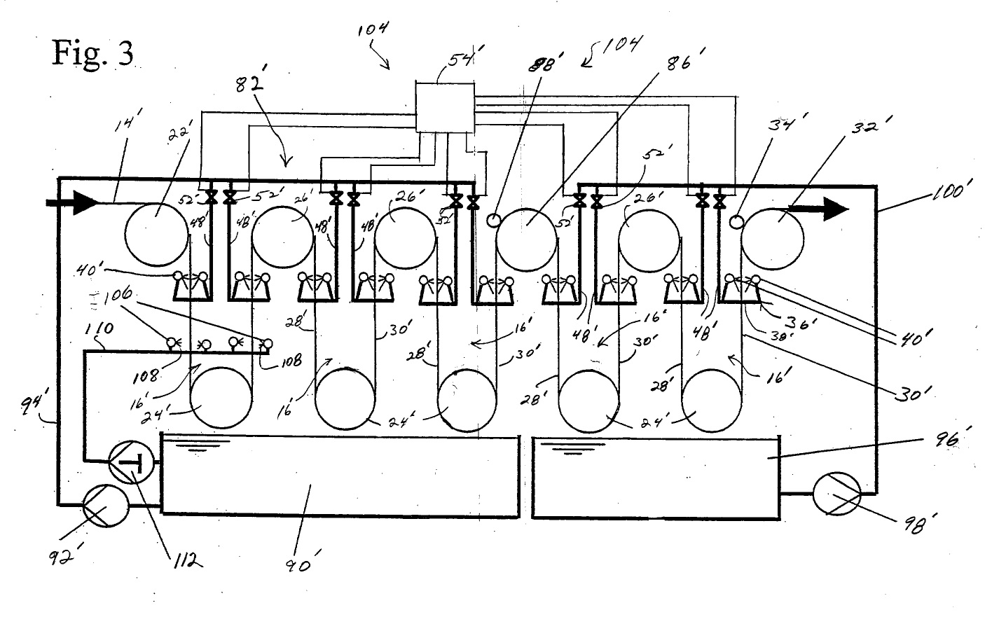

In FIG. 3, another embodiment of the pickling apparatus 104 is shown. Pickling apparatus 104 is substantially similar to apparatus 10 and apparatus 80 so that identical elements are identified by the same reference number with the addition of a prime.

Liquid dispensing units 38′ include an overflow to form a waterfall-like flow of the pickling medium onto strip material 14′. The continuous flow of the pickling medium produces a highly turbulent descending film along strip material 14′ as it is conveyed through apparatus 104. In the embodiment of FIG. 3, secondary spray nozzles 106 are provided within one or more of pickling cells 16′ to direct a supplemental spray of the pickling medium onto strip material 14′. As shown in FIG. 3, a supply line 110 extends from collection tank 90′ to four secondary spray nozzles 106 positioned on opposite sides of strip material 14′. A high pressure pump 112 is provided to supply the pickling medium from first collection tank 90 to secondary spray nozzles 106. In alternative embodiments, spray nozzles 106 can be connected to a rinse liquid such as water to direct a rinse liquid directly to strip material 14′.

In the operation of apparatus 104, selected pickling cells 16′ and liquid dispensing units 38′ can be deactivated to selectively control the effective length of the pickling treatment of strip material 14′. Typically, pickling cells 16′ at the upstream end of apparatus 104 are deactivated when less than all of the pickling cells 16′ are required to supply the pickling medium. Secondary spray nozzles 106 can supply a rinse liquid to strip material 14′ within the upstream pickling cell 16′ to keep strip material 14′ wet or moist to prevent streaking and staining.

While various embodiments of the invention have been described herein, it will be appreciated that various changes and modifications can be made without departing from the scope of the invention as defined in the appended claims.

What is claimed is:

1. A pickling apparatus for pickling a continuous material, said pickling apparatus comprising:
a first liquid treating cell having a feed device for continuously feeding said continuous material in a substantially vertical loop having first and second vertical sections, and a first fluid supply device for supplying said pickling liquid onto said continuous material on said first and second vertical sections;
at least one second liquid treating cell having a feed device for receiving said continuous strip from said first liquid treating cell and continuously feeding said continuous material in a substantially vertical loop having first and second vertical sections, and a second fluid supply device for supplying said pickling liquid onto said continuous strip on said two vertical sections; and
a control device connected to said first liquid supply device and to said second liquid supply device for independently controlling a flow of said pickling liquid from said first liquid supply device and said second liquid supply device.

2. The apparatus of claim 1, wherein said control device independently activates and deactivates said first fluid supply device in said first liquid treating cell and said second fluid supply device in said at least one second liquid treating cell.

3. The apparatus of claim 1, wherein said feed device comprises a roller positioned in a lower end of said liquid treating cell whereby said continuous material travels downwardly to define said first vertical section, around said roller and upwardly to define said second vertical section.

4. The apparatus of claim 1, wherein each of said liquid treating cells have an upper roller and a lower roller defining said feed device for feeding said continuous material in said vertical loop, said liquid treating cells being positioned whereby said continuous material is fed from said lower roller of said first liquid treating cell to an upper roller of said at least one second liquid treating cell.

5. The apparatus of claim 1, wherein said liquid supply device comprises a first spray nozzle positioned on a first side of said continuous material and a second spray nozzle positioned on a second side of said continuous material for directing a spray of said treating liquid against said first and second sides of said continuous material in each of said cells.

6. The apparatus of claim 1, wherein said first fluid supply device comprises a first delivery device for delivering said pickling liquid to said first vertical section of said first liquid treating cell and a second delivery device for delivering said pickling liquid to said second vertical section of said first liquid treating cell;
said second fluid supply device comprises a first delivery device for delivering said pickling liquid to said first vertical section of said second liquid treating cell and a second delivery device for delivering said pickling liquid to said second vertical section of said second liquid treating cell; and
said control device being coupled to each of said delivery devices for independently controlling said delivery devices.

7. The apparatus of claim 1, comprising at least five of said liquid treating cells arranged in sequence and where each of said liquid treating cells have a first and second vertical section.

8. The apparatus of claim 6, wherein each of said delivery devices include an overflow to supply a continuous flow of said pickling liquid onto said continuous material.

9. The apparatus of claim 1, further comprising a plurality of secondary spray nozzles for spraying said pickling liquid to said continuous material at an upstream end of said apparatus and in at least one of said liquid treating cells.

10. The apparatus of claim 1, further comprising at least one mist projector for directing a mist of a rinse liquid onto said continuous material.

11. The apparatus of claim 1, further comprising a collection tank positioned below said liquid treating cells and continuous material for collecting said pickling liquid and a pump extending from said collection tank to said first and second liquid supply devices for supplying pickling liquid to said first and second supply devices.

12. The apparatus of claim 1, wherein said feed device in said first liquid treating cell is adjustable to adjust the length of said first vertical section of said continuous material.

13. The apparatus of claim 1, further comprising a pair of electrodes and an electric power source for applying an electric current to said pickling liquid on said continuous material.

14. A pickling apparatus for pickling a continuous material, said pickling apparatus comprising:
a plurality of liquid pickling cells arranged in sequence for treating said continuous material with a pickling liquid, each of said liquid pickling cells having a first guide roller at a top end of said treating cell and a second guide roller at a bottom end of said cell for guiding said continuous material in a substantially vertical loop having a first vertical section extending between said first guide roller and second guide roller and a second vertical section extending between said second guide roller and a first guide roller of an adjacent liquid pickling cell, each said cell having a liquid supply device for supplying said pickling liquid to said first and second vertical sections of said continuous material, and
a control device coupled to said liquid supply for selectively and independently controlling the supply of pickling liquid to each cell.

15. The apparatus of claim 14, wherein said control device independently activates and deactivates said liquid supply device in each of said liquid pickling cells.

16. The apparatus of claim 14, further comprising a first collection tank positioned below a first group of said liquid pickling cells for collecting pickling liquid from said continuous material, and a first conduit extending from said first collection tank to said liquid supply devices of said first group of liquid pickling cells; and
a second collection tank position below a second group of said liquid pickling cells for collecting pickling liquid from said continuous material, and a second conduit extending from said second collection tank to said liquid supply devices of said second group of liquid pickling cells.

17. The apparatus of claim 14, wherein said liquid supply device comprises a first spray nozzle positioned on a first side of said continuous material and a second spray nozzle positioned on a second side of said continuous material for directing a spray of said treating liquid against said first and second sides of said continuous material in each of said cells.

18. The apparatus of claim 17, wherein said first spray nozzle and said second spray nozzle are operatively connected to said control device, and wherein said control device selectively and independently operates said first and second spray nozzles.

19. The apparatus of claim 14, comprising at least five of said liquid pickling cells arranged in sequence and where each of said liquid pickling cells have a first and second vertical section.

20. The apparatus of claim 14, wherein each of said liquid supply devices include an overflow to supply a continuous flow of said pickling liquid onto said vertical sections of said continuous material.

21. The apparatus of claim 14, further comprising a spray device for spraying said pickling liquid to said continuous material at an upstream end of said apparatus and in at least one of said liquid treating cells.

22. The apparatus of claim 14, further comprising at least one mist projector for directing a rinse liquid onto said continuous material.

23. The apparatus of claim 14, further comprising a collection tank positioned below said liquid pickling cells and said continuous material for collecting said pickling liquid and a conduit extending from said collection tank to said liquid supply devices for recycling pickling liquid to said supply device.

24. The apparatus of claim 14, further comprising a pair of electrodes and an electric power source for applying an electric current to said pickling liquid on said continuous material.

25. The apparatus of claim 14, wherein an operating length between said first roller and second roller is adjustable to selectively increase or decrease the length of said first vertical section of said continuous material.

26. The apparatus of claim 25, wherein at least one of said second guide rollers is mounted on an adjustable member for adjusting a spacing between said second guide roller and a first guide roller of the respective pickling cell.

27. The apparatus of claim 14, wherein at least one of said liquid supply devices is mounted on an adjustable member for adjusting a spacing between said liquid supply device and a second guide roller of a respective pickling cell.

28. A process of pickling a continuous steel material, said process comprising the steps of:
feeding said continuous steel material through a plurality of sequentially arranged liquid treating cells, each of said cells having an upper guide roller and lower guide roller to guide said steel material in a substantially U-shaped loop within each of said cells and form a first and second vertical section;
providing a dispensing device in each of said cells for directing a pickling liquid onto each of said first and second vertical sections; and
selectively controlling each dispensing device to selectively operate said dispensing device within a cell independently of the operation of a dispensing device of another cell.

29. The process of claim 28, comprising independently activating and deactivating each said dispensing device in each said liquid treating cells.

30. The process of claim 28, wherein each said dispensing device includes a first liquid delivery device for delivering said pickling liquid to a first side of said steel material and a second delivering device for delivering said pickling liquid to a second side of said steel material, said method comprising actuating said first and second delivery devices independently of each other.

31. The process of claim 28, further comprising spraying a pickling liquid directly onto said first and second sections of said steel material in at least one of said cells.

32. The process of claim 28, wherein said steel material is selected from the group consisting of a continuous wire and a continuous sheet.

33. The process of claim 28, further comprising directing a flow of a rinse liquid onto said steel material after treating said steel material with said pickling liquid.

34. The process of claim 28, further comprising spraying said steel material with a rinse liquid after treating said steel material with said pickling liquid.

35. The process of claim 28, further comprising adjusting the length of said first and second sections of said steel material in at least one of said cells.

36. The process of claim 28, further comprising applying an electric potential to said steel material and electrolytically treating said steel material.
